(19) United States
(12) Patent Application Publication
(10) Pub. No.: US 2012/0118415 A1
(43) Pub. Date: May 17, 2012

(54) WATER-SAVING MIXING FAUCET

(76) Inventor: Claude Waudoit, Latour (BE)

(21) Appl. No.: 13/386,114

(22) PCT Filed: Jul. 22, 2010
(86) PCT No.: PCT/EP2010/060640

§ 371 Date: Jan. 20, 2012

(30) Foreign Application Priority Data
Jul. 22, 2009 (BE) 2009/00447

(51) Int. Cl. F16K 51/00

(52) U.S. Cl. 137/605

(57) ABSTRACT

The invention relates to a mixing water faucet, comprising a hot water inlet, a cold water inlet, and a service water outlet. The faucet also comprises a service flow adjustment valve which comprises an interconnection position enabling at least one first passage between the hot water inlet and the cold water inlet to be opened.

### CROSS-REFERENCE TO RELATED APPLICATIONS

The present invention is the US national stage under 35 U.S.C. §371 of International Application No. PCT/EP2010/060640, which was filed on Jul. 22, 2010 and which claims the priority of BE application 2009/0447 filed on Jul. 22, 2009 the content of which (text, drawings and claims) is incorporated here by reference.

### FIELD

The present teachings relate to a water-saving mixing faucet.

### BACKGROUND

The statements in this section merely provide background information related to the present disclosure and may not constitute prior art.

In a plumbing system comprising hot water pipes, the hot water source (water heater, hot water tank, etc.) can be at a considerable distance from the consumption points. When all of the consumption points are off, the water contained in these hot water pipes cools naturally. For that reason, when there is then a new request for hot water, it is normally necessary to allow the water initially contained in these pipes to run to be able to reach the desired water temperature of the consumption point. This is a considerable source of wasted water.

In French patent application FR 2,923,033 A1, a device was proposed to instantaneously provide hot water, comprising a hot water tank near the consumption point. However, in a plumbing system with a plurality of water consumption points, this will create considerable complexity and high costs. Furthermore, the effectiveness of the system is limited, in particular when the water consumption point is off for a prolonged period, or when a higher initial water temperature is desired.

Patent document DE 36 22 139 A1 discloses a domestic supply water distribution system with hot water and cold water, where the cold water part of the system is at a lower pressure than the hot water part of the system. The pressure difference is ensured by a pressure reducer. The cold water system part is also equipped with an expansion tank. At the different points of the hot water and cold water system, devices for interconnecting the hot water and cold water pipes are provided. These devices ensure interconnection when the temperature of the hot water pipe goes below a predetermined value, so as to ensure a slight flow of hot water toward the cold water pipe and maintain the presence of a minimum temperature in the hot water pipe.

Patent document DE 197 20 235 A1 discloses a single control thermostatic faucet. This faucet is intended to be connected to a hot and cold water distribution system where the cold water system portion is at a lower pressure than that of the hot water system portion, and allowing hot water to circulate toward the cold water. The faucet comprises an interconnection or bypass device for the hot water inlet with the cold water inlet so as to maintain a minimum temperature at the hot water inlet. This device is situated at the foot of the body of the faucet (at the lower portion thereof), positioned hydraulically between the hot and cold water inlets and the disc flow regulator. The faucet comprises two coupled thermostats, a first to regulate the service water temperature and a second to regulate the temperature maintained at the hot water inlet. A service flow at a selected temperature will only be authorized when the hot water inlet has reached a temperature close to the selected temperature. Furthermore, the bypass between the hot water inlet and the cold water inlet is sensitive to the pressure difference so as to avoid a reverse flow when the pressure decreases in the hot water pipe. This faucet has a very complex construction, and is consequently expensive.

### SUMMARY

An objective of the invention is to propose a faucet limiting wasted water by preserving the water that has cooled in the hot water pipe, using simple and economical means.

To that end, a water mixing faucet according to various embodiments of the invention comprises a hot water inlet, a cold water inlet, at least one service water outlet, and a service flow adjustment valve. The flow adjustment valve is provided with an interconnection position making it possible to open at least a first passage between the hot water inlet and the cold water inlet without connecting them to the service outlet.

The integration into the flow adjustment valve of the interconnection function of the hot water coming either directly from the hot water inlet in the case of a single-unit faucet, or from the outlet of the thermostat in the case of a thermostatic faucet, with the cold water inlet ensures notable simplification of the construction of the faucet so as to limit wasted water. This advantage can be identified in the various embodiments of the invention.

The first passage provides a direct or indirect connection of the hot water inlet with the cold water inlet. In fact, in the event of the presence of the thermostat for the service flow, the hot water inlet will be interconnected with the cold water inlet via a so-called “lukewarm” water flow leaving thermostat.

According to another advantageous embodiment of the invention, said faucet is a thermostatic faucet comprising a thermostat with a first inlet connected to the hot water inlet, a second inlet connected to the cold water inlet, to dose a water mixture arriving through the first and second inlets, and an outlet connected to the flow adjustment valve.

According to another advantageous embodiment of the invention, the flow adjustment valve is a separate element from the thermostat.

According to another advantageous embodiment of the invention, the flow adjustment valve is configured to perform the following functions: the connection of the thermostat outlet with the service outlet with adjustment of the flow, the connection of the thermostat outlet with the cold water inlet, and the closing of its first and second inlets, and preferably its outlet.

According to another advantageous embodiment of the invention, a body of the faucet is generally elongated and intended to be positioned horizontally, the thermostat being controlled by a first control wheel at a first end of said generally elongated body and the flow adjustment valve being controlled by a second control wheel at the opposite end of said body.

According to another advantageous embodiment of the invention, the first control wheel comprises a safety button limiting its rotation in the direction of a temperature increase, the faucet comprising means for blocking said button when the flow adjustment valve is in the interconnection position of the thermostat outlet with the cold water inlet.

According to another advantageous embodiment of the invention, the second control wheel comprises a safety button blocking the rotation of the wheel toward an interconnection position of the thermostat outlet with the cold water inlet, the body of the faucet comprising a locking rod positioned free in translation and whereof each end cooperates with the respective button of the first and second control wheels so as to prevent the two buttons from being actuated same time.

According to another advantageous embodiment of the invention, the flow adjustment valve comprises first and second discs relatively translatable in a contact plane, in which the first disc comprises a first opening connected to the outlet of the thermostat, a second opening connected to the cold water inlet, and the third opening connected to the service outlet, the second disc comprising, opposite the first disc, a cavity making it possible to connect the first opening with the third opening or, alternatively, the first opening with the second opening.

According to another advantageous embodiment of the invention, the second disc is rotatable and comprises a control rod for controlling the rotation of the thermostat, said rod passing through the first opening.

According to another advantageous embodiment of the invention, the faucet comprises a means for converting the rotational movement of the control rod of the thermostat into a translational movement.

According to another advantageous embodiment of the invention, the first opening is positioned in a central zone of the first disc.

According to another advantageous embodiment of the invention, the faucet comprises a rotating and tilting lever acting on the second disc so as to control the flow and temperature.

According to another advantageous embodiment of the invention, the faucet comprises a means for limiting the rotation of the rotating and tilting lever in an incline corresponding to the turning off of the service flow and the interconnection of the hot water inlet via the thermostat outlet with the cold water inlet.

According to another advantageous embodiment of the invention, the means for limiting the rotation of the rotating and tilting lever comprise a first stop rotationally mobile with the lever and a second stop preferably stationary relative to the body of the faucet, the first and second stops being positioned so as to cooperate, when the second disc is rotated and only in one of several relative positions in the contact plane that correspond(s) to the connection of the first opening with the second opening.

According to another advantageous embodiment of the invention, a rod pivotally mounted on the rotating support connects the rotating and tilting lever to the second disc and the first stop is positioned on said rod.

According to another advantageous embodiment of the invention, the second stop is arranged stationary relative to the body of the faucet, at a distance in a generally longitudinal direction of the pivot axis of the rod, so as only to cooperate with the first mobile stop by rotation of the latter in a particular incline range of said rod.

According to another advantageous embodiment of the invention, the body of the faucet is elongated and intended to be normally mounted vertically.

According to another advantageous embodiment of the invention, the thermostat is positioned parallel to the longitudinal axis of the body of the faucet.

According to another advantageous embodiment of the invention, the thermostat comprises a third return inlet and has an interconnection position in which the first inlet is put in communication with the flow adjustment valve and the third return inlet is put in communication with the second inlet and the cold water inlet pipe, and said flow adjustment valve also has an interconnection position in which the water outlet is closed and the thermostat outlet is put in communication with its third return inlet, so as to open the passage between the hot water inlet and the cold water inlet without connecting them at the service outlet.

According to one advantageous embodiment of the invention, the flow adjustment valve also ensures dosing of the hot and cold water mixture. This typically involves the case of a single-unit faucet without a thermostatic function.

According to another advantageous embodiment of the invention, the valve comprises a disc valve or cartridge including first and second discs relatively translatable and rotatable in a contact plane, in which the first disc comprises a first opening connected to the hot water inlet and a second opening connected to the cold water inlet, and the second disc comprises, opposite the first disc, a first cavity making it possible to connect the first and/or second opening with the service outlet, and a second cavity making it possible to connect the first opening to the second opening without connecting them to the service outlet. The disc valve or cartridge in question can be made at costs very close to those of a cartridge of a traditional single-unit faucet. Preferably, the first disc comprises a third opening connected to the service outlet.

According to another advantageous embodiment of the invention, the first passage between the hot water inlet and the cold water inlet comprises a thermostatic gate arranged so as to close the passage when the water arriving through the hot water inlet exceeds a predetermined temperature. In this way, the volume of water emptied from the hot water inlet pipe toward the cold water inlet pipe is limited to what is necessary to directly reach the desired temperature when the service outlet is open. Furthermore, this limits the risk of burns when the hot water pipe is of a nature to reach high temperatures. The thermostatic gate can assume the form of a plug obstructing or limiting the passage section as a function of the temperature reached.

According to another advantageous embodiment of the invention, said first passage also comprises a hydrostatic gate arranged to open a second passage between the hot water inlet and the cold water inlet following the opening of said first passage.

Also disclosed, combined or not combined with the preceding, is a water-saving device comprising, aside from a hot water inlet pipe, a cold water inlet pipe and a water outlet, a valve with an interconnection position making it possible to open at least a first passage between the hot water pipe and the cold water pipe without opening the water outlet. When the water in the hot water inlet pipe has therefore cooled, the water contained in the hot water inlet pipe can be discharged in the cold water inlet pipe until the water in the hot water inlet pipe reaches the desired temperature for consumption. The water outlet can then be opened to consume the water from the hot water inlet pipe at the desired temperature directly.

Normally, the hot water pipes are connected upstream of the cold water pipes through a water heating device. The hot water pipes are therefore normally at a pressure equal to or lower than the cold water pressures. To allow emptying of the hot water pipe toward the cold water pipe, the latter can advantageously have a pressure reducer upstream of the interconnection valve. More advantageously, the device can also comprise an expansion tank connected to the hot water inlet pipe. The volume of water transferred from the hot water inlet pipe to the cold water inlet pipe is thus reduced in the expansion tank of the cold water tank to be used with the cold water when the consumption point is open thereto.

Alternatively, the hot water inlet pipe can comprise a pipe upstream of the interconnection valve.

Advantageously, said interconnection valve can be integrated into a faucet connected to at least one hot water inlet pipe and the water outlet. In this way, the interconnection valve can be directly associated with the hot water consumption point.

Still more advantageously, said faucet can be a single-unit faucet. “Single-unit faucet” refers to a faucet with a single control to adjust both the total flow and the mixing ratio between the cold water and the hot water. In particular, said single-unit faucet can comprise first and second discs relatively translatable and rotatable in a contact plane, in which the first disc comprises a first opening connected to the hot water inlet pipe and a second opening connected to the cold water pipe, and the second disc comprises, opposite the first disc, a first cavity making it possible to connect the first and/or second opening with the water outlet, and a second cavity making it possible to connect the first opening to the second opening without connecting them to the water outlet. In this way, the emptying of the hot water inlet pipe can be controlled by the same control serving to adjust the flow and dosage of the water outlet.

Alternatively, the faucet can be a mixing faucet comprising a hot water valve connected to the hot water inlet pipe, and a cold water valve connected to the cold water inlet pipe, the hot water valve and cold water valve communicating with a same water outlet. In particular, the hot water valve can also be the interconnection valve.

Alternatively, the faucet can be a thermostatic faucet comprising a thermostatic valve with a first inlet connected to said hot water inlet pipe and a second inlet connected to said cold water inlet pipe to dose a mixture of water arriving through the two pipes, and a flow adjustment valve between an outlet of the thermostatic valve and said water outlet. In particular, the thermostatic valve comprises a third return inlet and has an interconnection position in which the first inlet is put in communication with the flow adjustment valve and the third return inlet is put in communication with the second inlet and the cold water inlet pipe, and said flow adjustment valve also has an interconnection position in which the water outlet is closed and the outlet of the thermostatic valve is put in communication with the third return inlet thereof, so as to open said passage between the hot water inlet pipe and the cold water inlet pipe without connecting them to the water outlet.

Advantageously, said first passage between the hot water inlet pipe and the cold water inlet pipe can comprise a thermostatic valve arranged to close the passage when the water arriving through the hot water inlet pipe exceeds a predetermined temperature. In this way, the volume of water emptied from the hot water inlet pipe toward the cold water inlet pipe is limited to what is necessary to reach the desired temperature directly when the water outlet is open.

Advantageously, said first passage also comprises a hydrostatic valve arranged to open a second passage between the hot water inlet pipe and the cold water inlet pipe following the opening of said first passage. In this way, the flow from the hot water inlet pipe toward the cold water inlet pipe is increased.

The present invention also relates to a water-saving method in which the water in a hot water inlet pipe downstream of a water heating device and/or a hot water tank is transferred toward a cold water inlet pipe until the water in the hot water inlet pipe is hot enough. Advantageously, said cold water inlet pipe comprises an expansion tank receiving the volume of water transferred from the hot water inlet pipe to the cold water inlet pipe

Further areas of applicability of the present teachings will become apparent from the description provided herein. It should be understood that the description and specific examples are intended for purposes of illustration only and are not intended to limit the scope of the present teachings.

### DRAWINGS

Details relative to the invention are described below in reference to the drawings.

FIG. 1 is a diagrammatic drawing showing a first example of a hydraulic circuit forming a water saving device.

FIG. 2 is a diagrammatic drawing showing a second example of a hydraulic circuit forming a water saving device.

FIG. 3 is a diagrammatic drawing showing a third example of a hydraulic circuit forming a water saving device.

FIG. 4 is a diagrammatic drawing showing a fourth example of a hydraulic circuit forming a water saving device.

FIGS. 5 and 5a-5d are diagrammatic drawings showing various embodiments of the invention.

FIG. 6 is a diagrammatic drawing showing other embodiments of the invention.

FIG. 7 is a diagrammatic drawing showing yet other a third embodiments of the invention.

FIG. 8 is an illustration of still other embodiments of the invention.

FIG. 9 is an illustration of still yet other embodiments of the invention.

FIG. 10 is an illustration of still further embodiments of the invention.

FIG. 11 is a cross-sectional view along A-A of FIG. 10.

### DETAILED DESCRIPTION

FIG. 1 shows a first example of a hydraulic circuit forming a water-saving device 100 comprising a cold water inlet pipe 1, a hot water inlet pipe 2, and a faucet 3. The faucet 3 is a mixing faucet with a manually controlled valve 3a for the cold water, a manually controlled valve 3b for the hot water and an outlet 3e. The hot water inlet pipe 2 bypasses the cold water pipe 1 in a branch 4 and comprises a heat exchanger 5 and an expansion tank 6.

The hot water inlet pipe 2 is also connected, downstream of said heat exchanger 5 and expansion tank 6, to the cold water inlet pipe 1 through a first passage I comprising an interconnection valve 7. Preferably, this valve 7 is installed as close as possible to the faucet 3, and can even be incorporated into the body of the faucet 3.

The cold water inlet pipe 1 also comprises an expansion tank 8 and, upstream of said expansion tank 8 and the interconnection valve 7, but downstream of the branch 4, a pressure reducer 9.

During operation, when the hot water valve 3b remains closed for a prolonged period, the hot water contained in the pipe 2 cools. To obtain hot water from the faucet 3, it is therefore first necessary to empty the water contained in the pipe 2 between the heat exchanger 5 and the valve 3b. So as not to waste that water, the valve 7 is placed in an interconnection position thereby allowing the passage I of water from the hot water inlet pipe 2 toward the cold water inlet pipe 1 and into the expansion tank 8. Upon arrival of the hot water coming from the exchanger 5, the valve 7 may be closed. The water received in the expansion tank 8 may then be consumed normally as cold water through the valve 3a of the faucet 3 or through another cold water consumption point of the facility.

Both the cold water inlet pipe 1 and the hot water inlet pipe 2 can be connected to alternative outlet pipes 1′, 2′, as illustrated in FIG. 1.

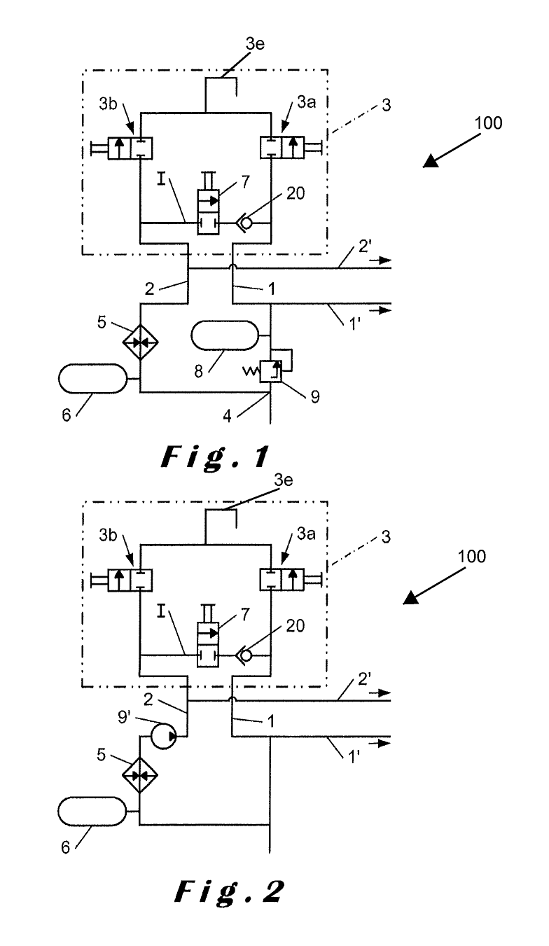

In a second example of a hydraulic circuit forming the water-saving device 100 illustrated in FIG. 2, the overpressure of the hot water inlet pipe 2 relative to the cold water inlet pipe 1 is obtained using a pump 9′ in the hot water inlet pipe 2, in place of the pressure reducer in the cold water pipe of the first embodiment illustrated in FIG. 1.

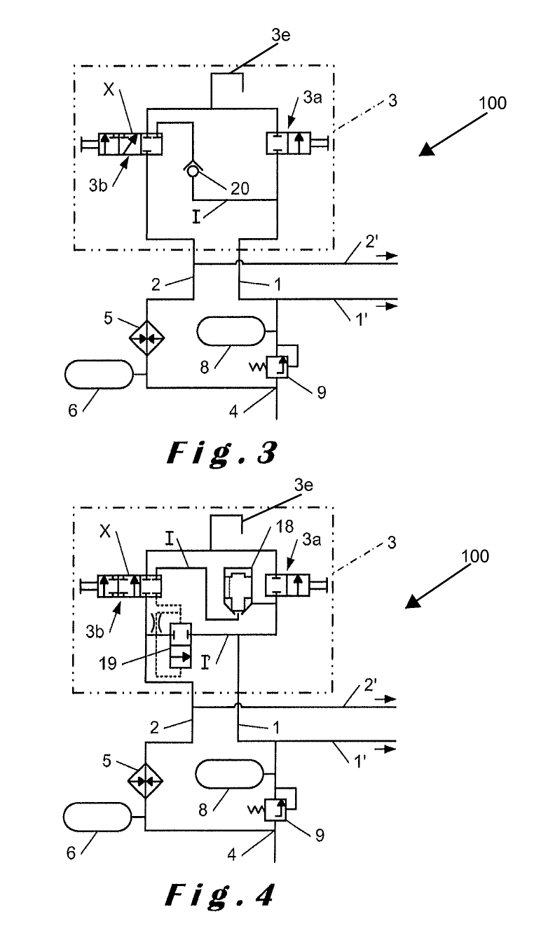

In a third example of a hydraulic circuit forming the water-saving device 100 illustrated in FIG. 3, the hot water valve 3b comprises a closed position, an open position in which the hot water inlet pipe 2 is put in communication with the water outlet 3e, and an interconnection position X in which the hot water pipe 2 is put in communication with the cold water pipe 1 through the passage I between the two. In this way, a separate interconnection valve is no longer required.

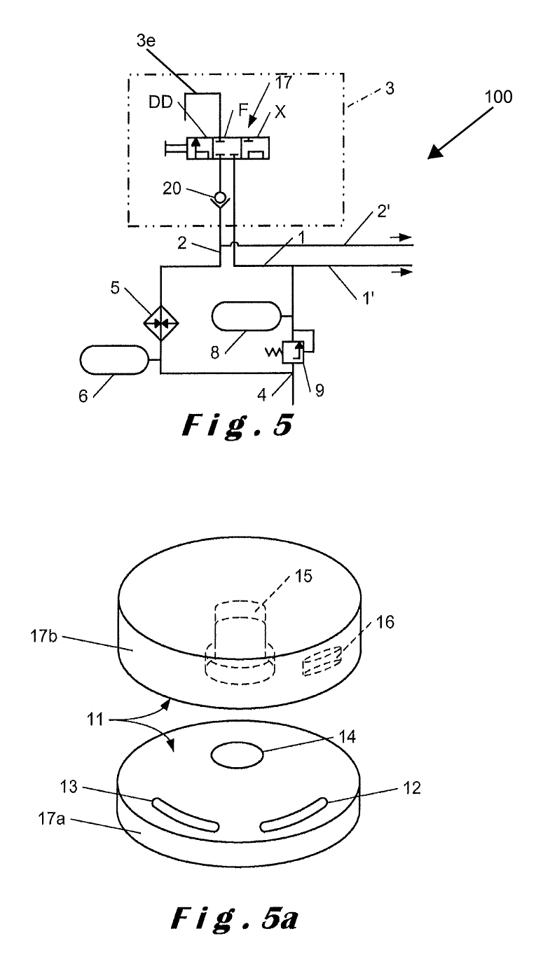

In a fourth example of a hydraulic circuit forming the water-saving device 100, similar to the third example and illustrated in FIG. 4, a thermostatic plug 18 is integrated into the passage I between the pipes 1 and 2. This thermostatic plug 18 has such a heat expansion coefficient that the interconnection passage I is blocked once the water arriving through the hot water inlet pipe 2 reaches a predetermined temperature. In this way, only the necessary volume of water from the hot water inlet will be discharged from the pipe 2 toward the pipe 1. Furthermore, the water-saving device 100 of this fourth embodiment also comprises a second interconnection passage I′ with a hydrostatic gate 19 opening when the first passage I puts the pipes 2 and 1 in communication. In this way, this second interconnection passage I′ acts as an amplifier of the flow of the first passage I.

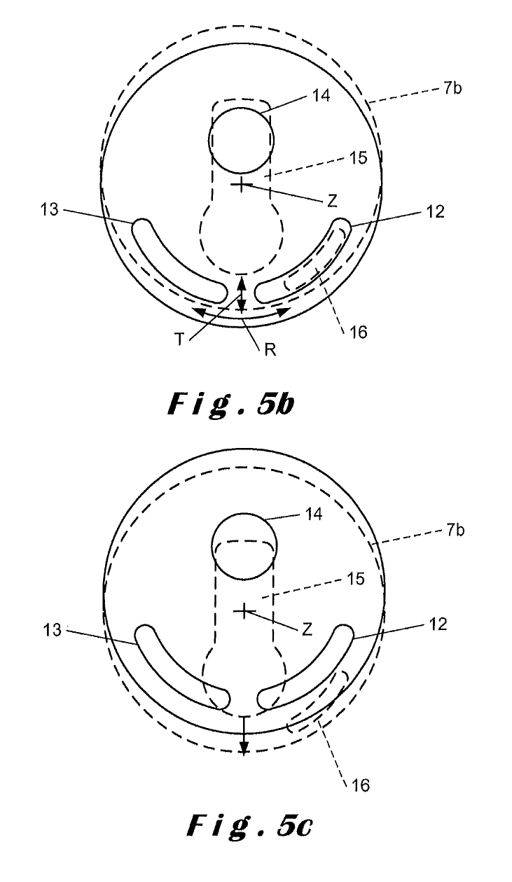

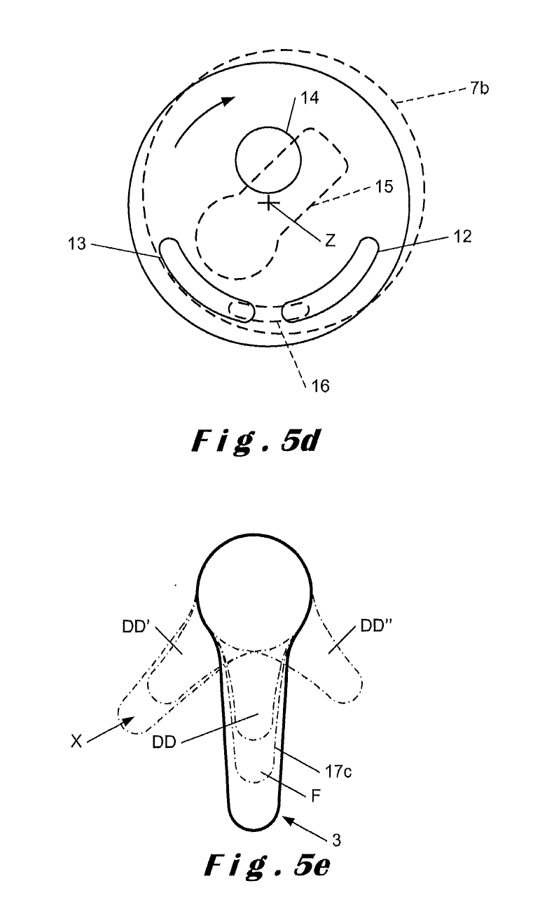

In various embodiments of the invention illustrated in FIGS. 5 and 5a-5e, the faucet 3 is a single control single-unit faucet, and a same valve 17 in the faucet 3 operates as a flow adjusting and dosing valve for the faucet 3 and also offers at least one interconnection position X of the hot and cold water inlet pipes 2 and 1 without opening the water outlet 3e of the faucet 3. The branch 4, the heat exchanger 5, the expansion tanks 6 and 8, as well as the pressure reducer 9 are all arranged similarly to the first example of the hydraulic circuit forming the water-saving device 100 illustrated in FIG. 1. The usage method of these embodiments is also similar to that of the first example: when one wishes to discharge the water contained in the hot water pipe 2 after a prolonged period during which the faucet 3 was off with the valve 17 in a position F, one places the valve 17 in an interconnection position X of the pipes 1 and 2. Upon the arrival of hot water coming from the exchanger 5, the valve 17 may be put in a dosage and flow adjusting position DD of a mixture of water coming from the pipe 1 and pipe 2.

FIG. 5a shows a diagrammatic view of the valve 17 according to various embodiments. The valve 17 is contained in a standardized cartridge (not shown) and comprises a first stationary disc 17a and a second disc 17b in contact with the first disc 17a on a contact plane 11. The second disc 17b can be translated and rotate relative to the first disc 17a in the plane 11. The first disc 17a comprises a first through opening 12 connected to the hot water inlet pipe 2, a second through opening 13 connected to the cold water inlet pipe 1, and a third through opening 14 connected to the water outlet. The second disc 17b comprises, opposite the first disc 17a, a first cavity or blind hole 15 making it possible to connect the first and/or second opening 12, 13 with the third opening 14 and the water outlet 3e. As illustrated in FIGS. 5b and 5c, the adjustment of the total flow is done by translating the disc 17b relative to the disc 17a in direction T. The dosage of the mixture of hot and cold water is then done by rotating the disc 17b relative to the disc 17a in direction R. The disc 17b also comprises a second cavity or blind hole 16 making it possible to connect the first opening 12 to the second opening 13 without connecting them to the third opening 14 and the water outlet 3e. As illustrated in FIG. 5d, this can be done by rotating the disc 17b, relative to the disc 17a, around the axis Z without translating it.

In a single command single-unit faucet 3 as illustrated in FIG. 5e, the translation of the disc 17b relative to the disc 17a can be controlled by a vertical angular movement of the lever 17c, while the rotation of the disc 17b relative to the disc 17a can be controlled by a horizontal angular movement of the same lever 17c. Thus, in the low and centered position F of the lever 17c, both the water outlet 3e of the faucet 3 and the passage between the pipes 1 and 2 are closed. In the raised and centered position DD of the lever 7c, the water outlet 3e of the faucet 3 is open both at the hot water inlet pipe 2 and the cold water inlet pipe 1. In positions DD′ and DD″, in which the lever 7c is raised and rotated to the right or left, the water outlet 3e of the faucet 3 is open only at one or the other of the pipes 1 and 2. While in position X, in which the lever 7c is not raised, but is turned to the left, the passage I between the pipes 1 and 2 is open as in FIG. 5d.

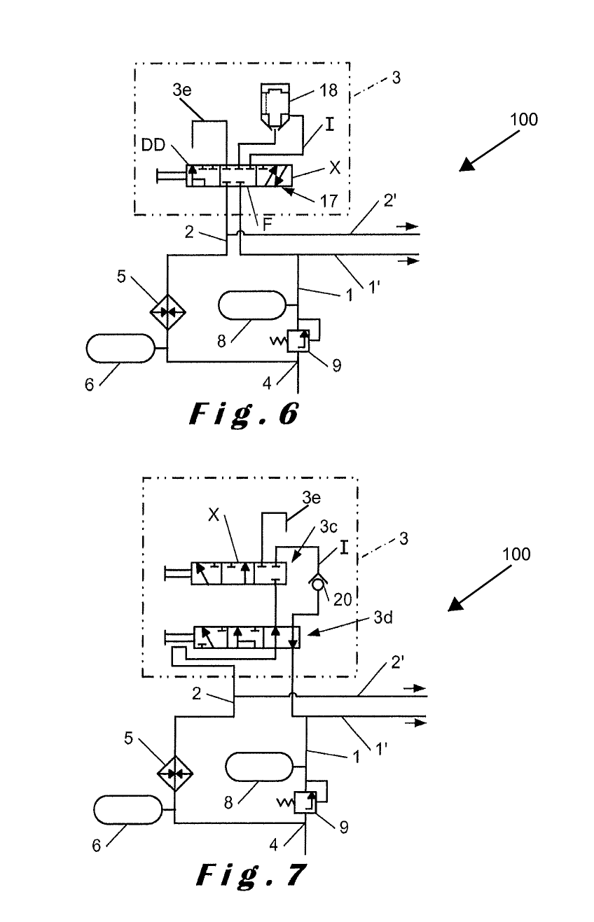

FIG. 6 diagrammatically illustrates other embodiments of the invention, in which a thermostatic plug 18 is incorporated into the passage between the cold and hot water inlet pipes 1 and 2 in the single-unit faucet 3. This thermostatic plug 18 has such a heat expansion coefficient that said interconnection passage of the cold and hot water inlet pipes 1 and 2 is blocked once the water arriving by the hot water inlet pipe 2 reaches a predetermined temperature. In this way, only the volume of water necessary from the hot water inlet pipe 2 will be discharged from the hot water inlet pipe 2 toward the cold water inlet pipe 1.

In yet other embodiments of the invention illustrated in FIG. 7, the faucet 3 is a thermostatic faucet, with a flow adjustment valve 3c downstream of a thermostatic adjustment valve 3d for dosing the water mixture coming from the cold water inlet pipe 1 and the hot water inlet pipe 2. The thermostatic valve 3d has a first inlet connected to the hot water inlet pipe 2, a second inlet connected to the cold water inlet pipe 1, and an outlet connected to an inlet of the flow adjustment valve 3c. The flow adjustment valve 3c comprises the single inlet, a first outlet in communication with the water outlet 3c, and a second outlet in communication with a third inlet of the thermostatic valve 3d by the interconnection passage I. The branch 4, the heat exchanger 5, the expansion tanks 6 and 8, as well as the pressure reducer 9 are all arranged similarly to the first example of the hydraulic circuit shown in FIG. 1. Since the thermostatic valve 3d only allows the passage of water arriving through the hot water pipe 2, and closes the water inlet by the cold water pipe 1, as long as the temperature of the water arriving by the hot water pipe 2 is not sufficient, the usage method of this device is: when one wishes to discharge the hot water pipe 2 after a prolonged period during which the faucet 3 was closed with the valve 3a in the closed position, one places the valve 3c in the interconnection position X, and the water coming from the hot water pipe 2 will begin to flow through the thermostatic valve 3d and the valve 3c toward the interconnection passage I and, through the thermostatic gate 3d, toward the cold water pipe 1 and the expansion tank 8. When the water cooled in the pipe 2 has finally flowed through the passage I, and the hot water begins to arrive through the same pipe 2, the passage I will be closed through the action of the thermostatic gate 3d and the flow and dosing of the cold and hot water mixture correctly adjusted by the valves 3c and 3d.

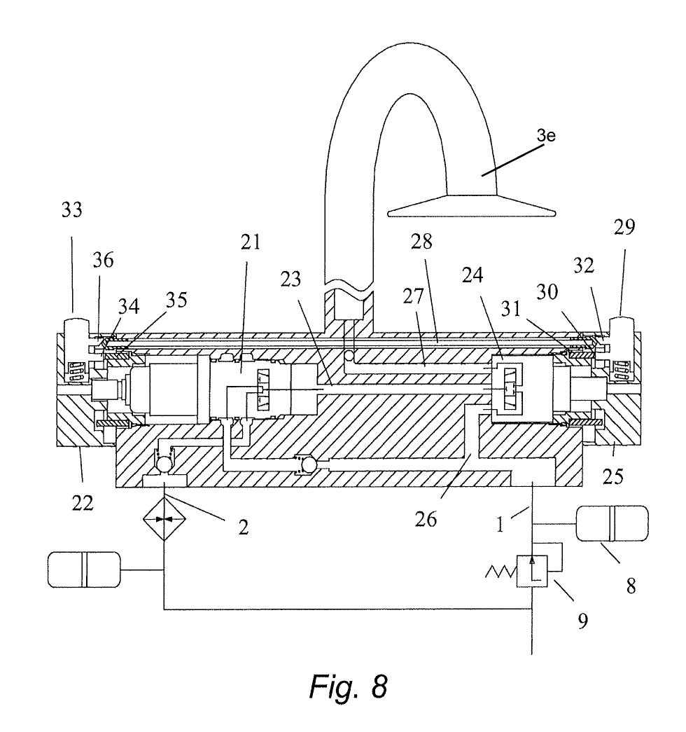

According to still other embodiments of the invention, FIG. 8 illustrates a single-unit faucet interchangeable with a typical shower or bath-shower faucet with two inlets. A thermostatic cartridge 21 controlled by an adjustment button 22 adjusts the temperature of the lukewarm water in pipe 23. The cartridge of a selector 24 closes the passage of the warm water of the pipe 23 in a first position of a control button 25. In a second position of the control button 25, which corresponds to the hot water preparation function, the lukewarm water of the pipe 23 is oriented toward the cold water expansion tank 8 via an internal passage 26 and the cold water inlet pipe 1. Due to the pressure difference between the hot water 2 and cold water 1 inlet pipes, only the cold water contained in the hot water circuit 2 circulates through the single-unit pipe until its temperature reaches the value adjusted by the adjustment button 22 of the thermostatic cartridge 21, which causes the interruption of the passage of the hot water through the thermostatic cartridge 21 and the stop of the water transfer. In a third position of the control button 25 that corresponds to the normal use of the shower, the lukewarm water of the pipe 23 is oriented toward the shower via an outlet 27.

As a safety measure, a rigid rod 28 causes the locking of the control buttons 22 and 25 to make it impossible to send, toward the cold water circuit 1, lukewarm water whereof the temperature is above 38° C. for example. To put the selector 24 in the hot water preparation mode, it is necessary to push a locking 29 of the button 25 downward to slide a first lug 30 below a ring 31. By pushing the locking 29 downward, a second lug 32 pushes the rigid rod 28 back to the left and the inner profile of the button 25 keeps the rigid rod 28 in that position for as long as the button 25 remains in the hot water preparation mode, which prohibits any downward movement of a locking 33 of the adjustment button 22 of the thermostatic cartridge 21, and consequently the selection of a temperature above 38° C.

If the control button 25 is not in the hot water preparation position, it is possible to push the locking 33 downward to slide a first lug 34 under a ring 35 and select a lukewarm water temperature above 38° C., which results in pushing the rod 28 to the right using a second lug 36, which prevents any downward movement of the locking 29, and consequently prohibits the selection of the hot water preparation mode for as long as the lukewarm water temperature is adjusted above 38° C.

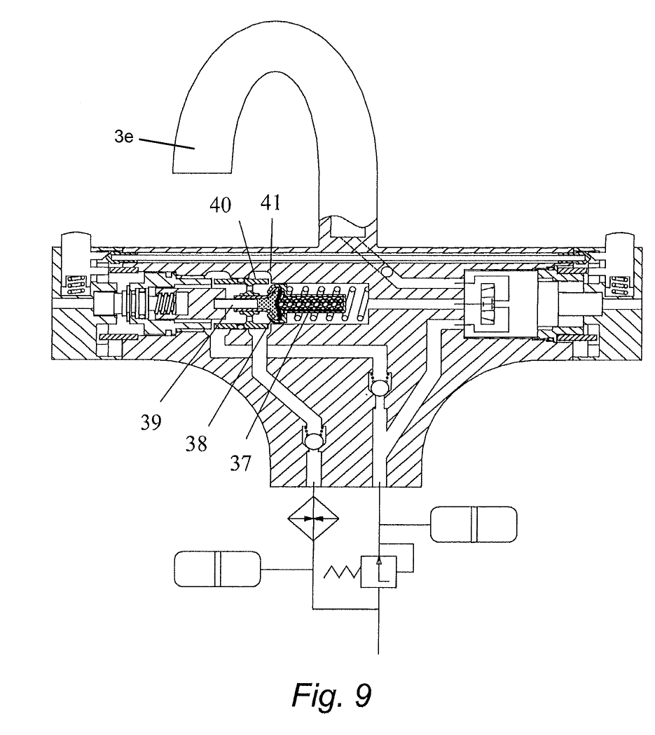

According to still yet other embodiments of the invention, FIG. 9 shows a single-unit faucet interchangeable with a single-hole single-unit faucet commonly used on wash basins and kitchen sinks. The thermostatic cartridge is a simpler model commonly used in single-unit faucets. The hot water inlet causes the expansion of a grains 37 in a thermostatic element 38, which pushes a piston 39 to the left and, through reaction effect, a slide 40 to the right to close the hot water inlet through a passage 41.

The thermostatic cartridge, the selector cartridge, and the check valves are well-known and commercially available elements. The block of the single-unit faucet, the control buttons with their mechanical locking system, and the locking rod are the new elements.

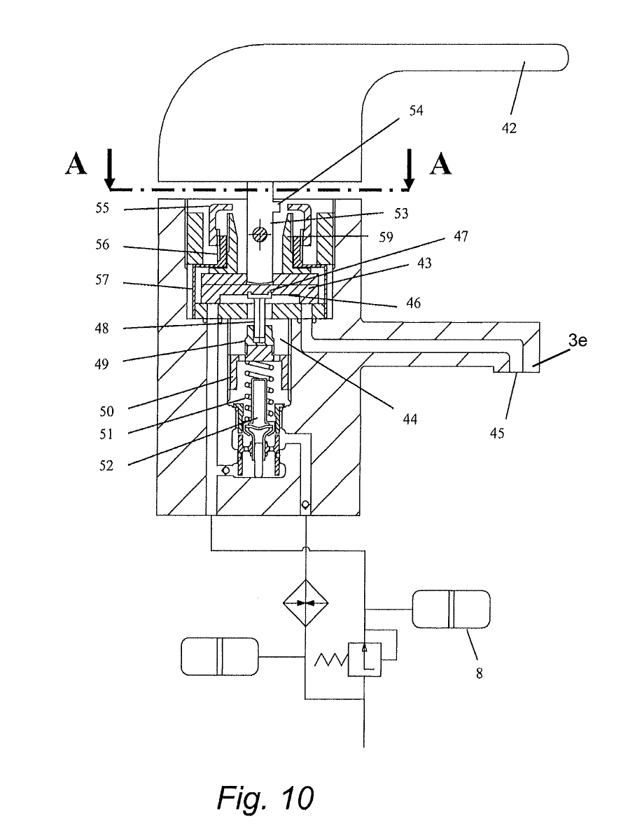

According to still further embodiments of the invention, FIG. 10 shows a single control thermostatic single-unit faucet. By pushing a control lever 42 downward, one causes a mobile ceramic disc 43 to move to the left, which corresponds to the hot water preparation position, the lukewarm water and a chamber 44 is sent toward the expansion tank 8.

By pushing the lever 42 upward, the lukewarm water of the chamber 44 is oriented toward an outlet 45 of the single-unit faucet.

The rotation of the lever 42 causes the mobile ceramic disc 43 to rotate. The ceramic disc 43 is characterized by its lower surface 46, which has cavities 47 capable of rotating the support of a square drive 48 and, via a sliding piece 49, a screwed piston 50. The rotation of the screwed piston 50 requires it to move vertically to compress a spring 51 and thereby modify the reference value of a temperature regulator 52. The sliding piece 49 can move laterally on the screwed piston 50, but it rotates it.

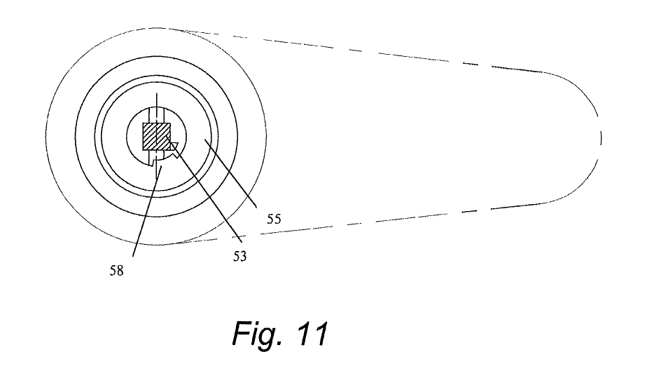

A rod 53 of the control lever 42 is pivotally mounted on a rotary support 59. The pivot axis is generally perpendicular to the longitudinal axis of the faucet. The rod 53 is provided with a lug 54. A ring 55 is adjustable in rotation and slid on splines 56 of a housing 57 of the cartridge of the selector, has a stop 58 (see cross-sectional view along A-A in FIG. 11) such that it comes into contact with the lug 54 when the lever 42, already pushed downward in the hot water preparation mode, is turned to the left to try to select a water temperature above 38° C.

The single-unit faucet operates like a standard faucet, but for a rotation of the lever situated between the extreme right, corresponding to the cold water, and intermediate position corresponding to a water temperature of 38° C. for example, it is possible to push the lever downward to benefit from the hot water preparation function.

The hot water preparation single-unit faucets shown in FIGS. 8, 9 and 10 are interchangeable with the current single-unit faucets and operate like normal single-unit faucets on an unmodified facility, but the hot water preparation function will only be operational after modifying the domestic supply water facility upstream.

A domestic supply water facility comprises, without drawbacks, normal withdrawal points and hot water preparation single-unit faucets as shown in FIGS. 8, 9 and 10.

Although the present invention has been described in reference to specific embodiments, various modifications and changes can of course be made to these examples without going beyond the general scope of the invention as defined by the claims. As a result, the description and drawings must be considered illustrative rather than restrictive.

1.-23. (canceled)

24. A water mixing faucet comprising:
a hot water inlet;
a cold water inlet;
at least one service water outlet; and
a service flow adjustment valve provided with an interconnection position making it possible to open at least a first passage between the hot water inlet and the cold water inlet without connecting them to the service outlet.

25. The faucet according to claim 24, wherein said faucet is a thermostatic faucet comprising a thermostat with a first inlet connected to the hot water inlet, a second inlet connected to the cold water inlet, and an outlet connected to the flow adjustment valve, the thermostat structured and operable to dose a water mixture arriving through the first and second inlets.

26. The faucet according to claim 25, wherein the flow adjustment valve is a separate element from the thermostat.

27. The faucet according to any claim 26, wherein the flow adjustment valve is structured and operable to:
connect the thermostat outlet with the service outlet and control the flow of water therebetween; and
connect the thermostat outlet with the cold water inlet and control the operation of at least one of a first adjustment valve inlet, a second adjustment valve inlet, and an adjustment valve outlet.

28. The faucet according to claim 27, wherein a body of the faucet is generally elongated and intended to be positioned horizontally, the thermostat being controlled by a first control wheel at a first end of said generally elongated body and the flow adjustment valve being controlled by a second control wheel at the opposite end of said body.

29. The faucet according to claim 28, wherein the first control wheel comprises a first safety button limiting its rotation in the direction of a temperature increase, the faucet comprising a means for blocking said button when the flow adjustment valve is in a position interconnecting the thermostat outlet with the cold water inlet.

30. The faucet according to claim 29, wherein the second control wheel comprises a second safety button blocking the rotation of the wheel toward a position interconnecting the thermostat outlet with the cold water inlet, the body of the faucet comprising a locking rod having opposing end connected to the first and second control wheels, the locking rod structured and operable to prevent the first and second safety buttons from being actuated at the same time.

31. The faucet according to claim 27, wherein the flow adjustment valve comprises a first disc and an opposing second disc translatable with respect to each other in a contact plane, in which the first disc comprises a first opening connected to the outlet of the thermostat, a second opening connected to the cold water inlet, and the third opening connected to the service outlet, the second disc comprising a cavity structured and operable to selectively connect the first opening with the third opening or the first opening with the second opening.

32. The faucet according to claim 31, wherein the second disc is rotatable and comprises a control rod for controlling the rotation of the thermostat, said rod passing through the first opening.

33. The faucet according to claim 32, wherein the faucet further comprises a means for converting the rotational movement of the control rod of the thermostat into a translational movement.

34. The faucet according to claim 33, wherein the first opening is positioned in a central zone of the first disc.

35. The faucet according to claim 34, wherein the faucet further comprises a rotating and tilting lever acting on the second disc so as to control the flow and temperature.

36. The faucet according to claim 35, wherein the faucet further comprises a means for limiting the rotation of the lever in an incline corresponding to the turning off of the service flow and the interconnection of the hot water inlet via the thermostat outlet with the cold water inlet.

37. The faucet according to claim 36, wherein the means for limiting the rotation of the lever comprise a first stop rotationally mobile with the lever and a second stop stationary relative to the body of the faucet, the first and second stops cooperatively positioned such that when the second disc is rotated to a particular one of several positions the first opening is fluidly connected with the second opening.

38. The faucet according to claim 37, wherein a connection rod pivotably mounted on the rotating support connects the lever to the second disc and the first stop is positioned on said rod.

39. The faucet according to claim 38, wherein the second stop is arranged stationary relative to the body of the faucet, at a distance in a generally longitudinal direction of a pivot axis of the connection rod, so as only to cooperate with the first mobile stop by rotation of the connection rod in a particular incline range of the connection rod.

40. The faucet according to claim 39, wherein the body of the faucet is elongated and intended to be normally mounted vertically.

41. The faucet according to claim 40, wherein the thermostat is positioned parallel to a longitudinal axis of the body of the faucet.

42. The faucet according to claim 26, wherein the thermostat comprises a third return inlet and has an interconnection position in which the first inlet is put in communication with the flow adjustment valve and the third inlet is put in communication with the second inlet and the cold water inlet pipe, and said flow adjustment valve also includes an interconnection position in which the water outlet is closed and the thermostat outlet is put in communication with third return inlet, so as to open the passage between the hot water inlet and the cold water inlet without connecting them to the service outlet.

43. The faucet according to claim 24, wherein the flow adjustment valve is structured and operable to control dosing of the hot and cold water mixture.

44. The faucet according to claim 43, wherein the flow adjustment valve comprises a first disc and an opposing second disc translatable relative to each other and rotatable in a contact plane, in which the first disc comprises a first opening connected to the hot water inlet and a second opening connected to the cold water inlet, and the second disc comprises a first cavity structured and operable to selectively connect the first opening with service outlet and/or the second opening with the service outlet, and a second cavity structured and operable to connect the first opening to the second opening without connecting either of the first and second openings to the service outlet.

45. The faucet according to claim 44, wherein the first passage between the hot water inlet and the cold water inlet comprises a thermostatic gate structured and operable to close the first passage when the water arriving through the hot water inlet exceeds a predetermined temperature.

46. The faucet according to claim 45, wherein said first passage further comprises a hydrostatic gate structured and operable to open a second passage between the hot water inlet and the cold water inlet following the opening of said first passage.
